(19) United States
(12) Patent Application Publication
(10) Pub. No.: US 2016/0343497 A1
(43) Pub. Date: Nov. 24, 2016

(54) MAGNETICALLY COUPLED SLIDERS

(71) Applicant: Advanced Input Devices, Inc., Coeur d'Alene, ID (US)

(72) Inventors: Jim Clark, Spokane, WA (US); Kevin Organ, Hayden, ID (US)

(21) Appl. No.: 14/919,439

(22) Filed: Oct. 21, 2015

Related U.S. Application Data
(60) Provisional application No. 62/165,530, filed on May 22, 2015.

(51) Int. Cl. H01F 21/06; H01C 10/30; H01H 36/00

(52) U.S. Cl. CPC H01F 21/065; H01H 36/0073; H01C 10/30

(57) ABSTRACT

An input device can include a bezel having a slot, a knob including a magnetic element positioned to slide through the slot, a housing having a channel, a slider including a sensory path positioned within the channel and magnetically coupled to the magnetic element, and a circuitry layer positioned between the knob and the housing.

### BACKGROUND

1. Technical Field

The present disclosure generally relates to human-machine interfaces, and more particularly to sliding switches or sliding variable controls.

2. Description of the Related Art

Various devices exist that allow humans to interact with machines. These include switches, potentiometers, and keyboards. Ingress of moisture and debris into many such devices can cause deterioration or malfunction.

### BRIEF SUMMARY

An input device may be summarized as including: a knob including a first magnetic element; a housing; a slider positioned within the housing; a circuitry layer positioned between the knob and the housing; and the slider including a second magnetic element magnetically coupled to the first magnetic element to move the slider within the housing to interact with the circuitry layer as the knob moves.

The circuitry layer and the slider may form a continuously variable resistor. The circuitry layer and the slider may form a single-pole, single-throw switch. The input device may be coupled to an ultrasound system. The housing may be sealed and the slider may be isolated from an external environment. The first magnetic element may be a magnet and the second magnetic element may be a ferrous metal. The first magnetic element may be a ferrous metal and the second magnetic element may be a magnet. The first magnetic element may be a first magnet having a first polarity and the second magnetic element may be a second magnet having a second polarity, the first polarity opposite to the second polarity. The slider may include a conductive pathway. The circuitry layer may be positioned between the knob and the slider or between the slider and the housing. The input device may further include a bezel including a slot, wherein the knob is positioned to slide through the slot.

A method may be summarized as including: positioning a slider including a first magnetic element within a housing; positioning a circuitry layer to communicatively interact with the slider; and positioning a knob including a second magnetic element so the circuitry layer is positioned between the knob and the housing and so the second magnetic element is magnetically coupled to the first magnetic element, so the slider moves within the housing and communicatively interacts with the circuitry layer as the knob moves.

The method may further include moving the knob, thereby moving the slider within the housing such that the slider communicatively interacts with the circuitry layer. Moving the knob may include adjusting a continuously variable electrical signal. Moving the knob may include throwing a single-pole, single-throw switch. Moving the knob may include controlling an ultrasound system. The method may further include sealing the housing and isolating the slider from an external environment. The first magnetic element may be a magnet and the second magnetic element may be a ferrous metal. The first magnetic element may be a ferrous metal and the second magnetic element may be a magnet. The first magnetic element may be a first magnet having a first polarity and the second magnetic element may be a second magnet having a second polarity, the first polarity opposite to the second polarity. The circuitry layer may be positioned to conductively or inductively interact with the slider.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and may have been solely selected for ease of recognition in the drawings.

FIG. 1 is a top plan view of an input device including a magnetically coupled slider, according to at least one illustrated embodiment.

FIG. 2 is an exploded view of an input device including a magnetically coupled slider, according to at least one illustrated embodiment.

FIG. 3 is a cross-sectional illustration of the input device including a magnetically coupled slider of FIG. 2, taken along a line corresponding to line A-A shown in FIG. 1, according to at least one illustrated embodiment.

FIG. 4 is a detailed view of section B of the cross-sectional illustration of FIG. 3, according to at least one illustrated embodiment.

FIG. 5A is a schematic illustration of a first portion of a first control circuit, according to at least one illustrated embodiment.

FIG. 5B is a schematic illustration of a second portion of the first control circuit, according to at least one illustrated embodiment.

FIG. 6A is a schematic illustration of a first portion of a second control circuit, according to at least one illustrated embodiment.

FIG. 6B is a schematic illustration of a second portion of the second control circuit, according to at least one illustrated embodiment.

FIG. 7A is a schematic illustration of a first portion of a third control circuit, according to at least one illustrated embodiment.

FIG. 7B is a schematic illustration of a second portion of the third control circuit, according to at least one illustrated embodiment.

FIG. 8A is a schematic illustration of a first portion of a fourth control circuit, according to at least one illustrated embodiment.

FIG. 8B is a schematic illustration of a second portion of the fourth control circuit, according to at least one illustrated embodiment.

FIG. 9A is a schematic illustration of a first portion of a fifth control circuit, according to at least one illustrated embodiment.

FIG. 9B is a schematic illustration of a second portion of the fifth control circuit, according to at least one illustrated embodiment.

FIG. 10A is a schematic illustration of a first portion of a sixth control circuit, according to at least one illustrated embodiment.

FIG. 10B is a schematic illustration of a second portion of the sixth control circuit, according to at least one illustrated embodiment.

FIG. 11A is a schematic illustration of a first portion of a seventh control circuit, according to at least one illustrated embodiment.

FIG. 11B is a schematic illustration of a second portion of the seventh control circuit, according to at least one illustrated embodiment.

FIG. 12 is a cross-sectional illustration of an input device including a magnetically coupled slider and an inductive coil, according to at least one illustrated embodiment.

FIG. 13 is a plan view illustration of the inductive coil of FIG. 12, according to at least one illustrated embodiment.

FIG. 14 is a cross-sectional illustration of another input device including a magnetically coupled slider and an inductive coil, according to at least one illustrated embodiment.

FIG. 15 is a flow chart diagram showing a method of assembling an input device, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

The headings and Abstract of the Disclosure provided herein are for convenience only and do not limit the scope or meaning of the embodiments.

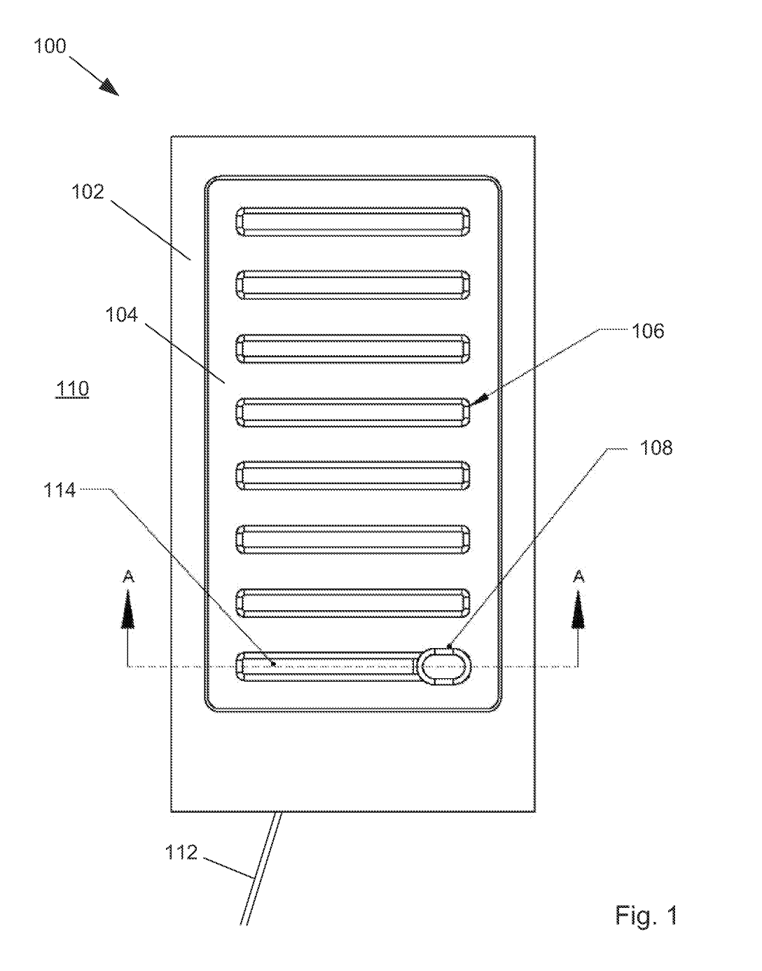

FIG. 1 shows an input device 100 that can be a component within a larger control panel. Input device 100 includes an outer frame 102, a bezel 104, a plurality of slots 106 extending generally parallel to one another through the bezel 104, and a plurality of knobs 108 (only one knob 108 is illustrated in FIG. 1), each of the knobs 108 slidably mounted within a respective one of the slots 106. The input device 100 can be mounted to an external surface 110, and can be electrically and/or communicatively coupled to other devices, machines, or power sources via a cable 112. The cable 112 can include one or more data, networking, or telecommunications cables for communicating information about the state of the knobs 108 from the input device 100 to devices or machines being controlled. The cable 112 can also include one or more power cables to provide power to components of the input device 100, such as internal lighting units.

Alternatively, the input device 100 can be a completely sealed and enclosed unit that is not connected via cables to other devices, machines, or power sources. For example, the input device 100 can include a wireless communications device such as a radio or Wi-Fi antenna to communicate information about the state of the knobs 108 from the input device 100 to devices or machines being controlled. The input device 100 can also include one or more batteries to provide power to components of the input device 100, such as to internal lighting units of the input device 100.

FIG. 1 illustrates that the input device 100 can include eight slots 106 and eight respective knobs 108, but in different embodiments, an input device can include any number of slots 106 and respective knobs 108. For example, in alternative embodiments, an input device can include a single slot 106 and a single knob 108, or exactly two slots 106 and exactly two knobs 108, or three, four, five, six, ten, twelve, or more slots 106 and respective knobs 108. FIG. 1 also illustrates that the plurality of slots 106 can be arranged to be generally parallel to one another, but in different embodiments, an input device can include slots 106 that are perpendicular to one another or oriented at any angle with respect to one another, as necessitated by the particular implementation and end-use of the input device.

The illustrated slots 106 are linear, but in different implementations, non-linear slots, such as curved, circular, oval, sawtooth, crenulated, or otherwise non-linearly shaped slots, can be used. In some implementations, the knobs 108 can move (e.g., translate, rotate, and/or pivot) freely, with a desired level of friction or tackiness, or in discrete distances specified by a set of detents, across the input device 100 in two dimensions. For example, a knob 108 can move in a first dimension through a slot 106 and the slot 106 can move in a second dimension, not parallel to the first dimension, across the input device 100. As another example, a knob 108 can be coupled to the input device 100 without being confined to move along the length of a slot. In any of these implementations, the input device 100 can include multiple knobs 108.

In use, the knobs 108 can be moved manually by a user to indicate a desired change in the operation of another device or machine to which the input device 100 is communicatively coupled. In this sense, the input device 100 and knobs 108 provide a generic user interface or human-machine interface. The input device 100 can be particularly useful in specific industries and applications, however. As examples, the input device 100 can be used to control the operation of lights (e.g., stage lighting), vehicles such as automobiles, motorcycles, boats, or aircraft, medical or veterinary devices such as medical imaging systems (e.g., ultrasound systems), entertainment systems such as radios, televisions, stereo systems, or gaming consoles or systems, telephones, cameras, professional audio equipment such as in sound and mixing boards in recording studios, video equipment such as video mixing boards, fitness and exercise equipment such as treadmills, and computers and laptops. In some cases, an input device as described herein can be integrated into another larger control system, such as a television or other remote control, or a keyboard or mouse for use with a laptop or desktop computer. In some cases, an input device as described herein can be used to control the volume (e.g., of a television or stereo system), the brightness (e.g., of lights or a computer screen), or the speed (e.g., of an aircraft or a treadmill), of another external device or machine.

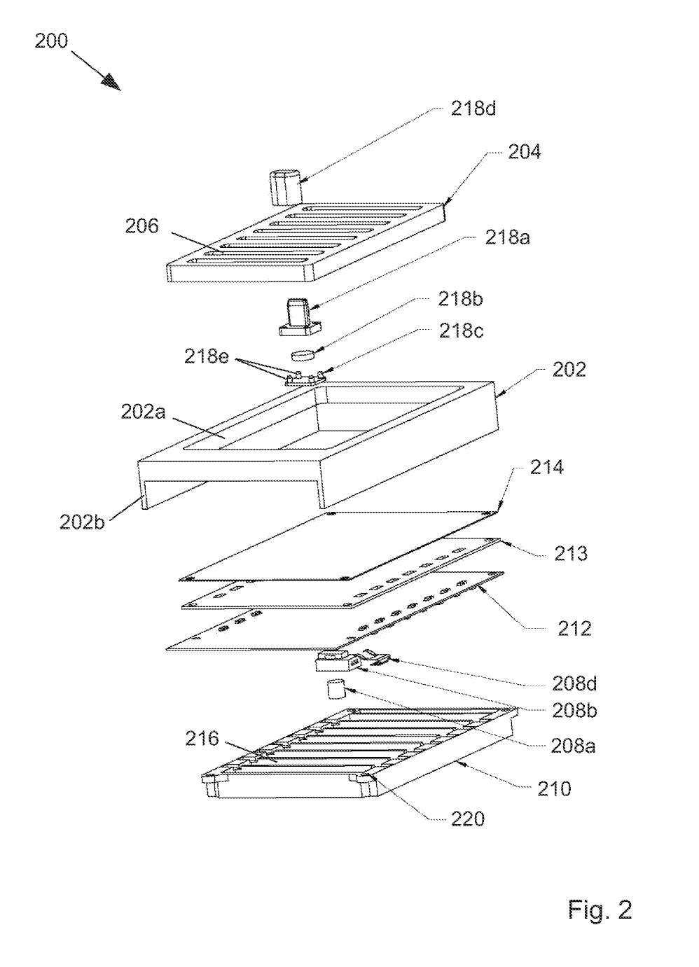

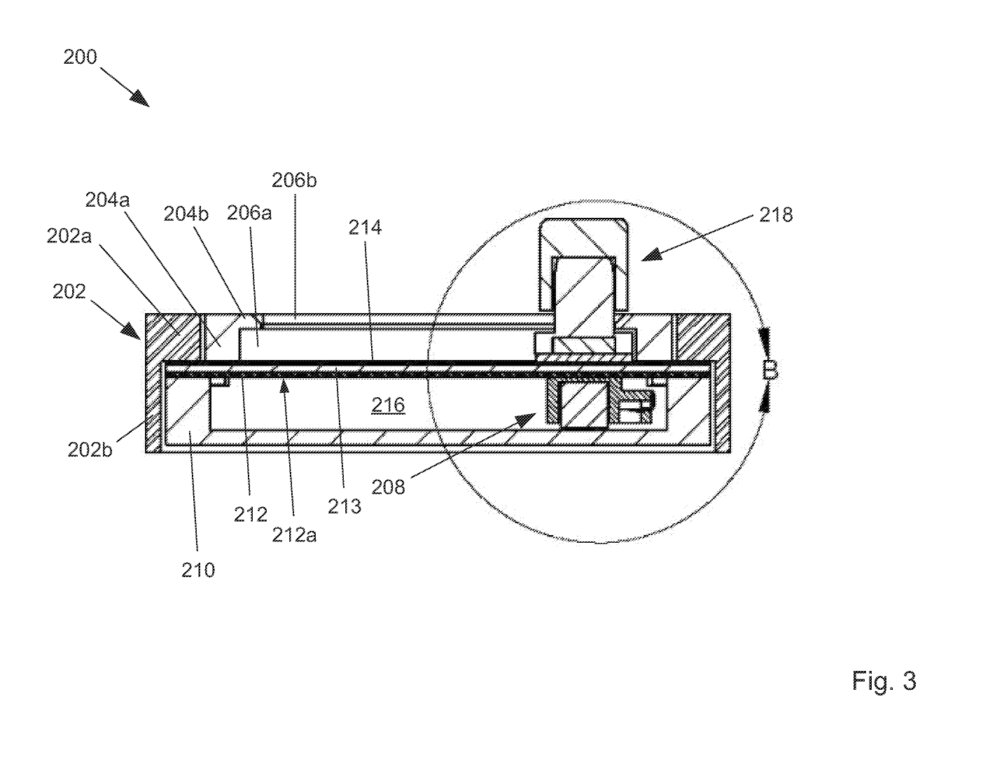

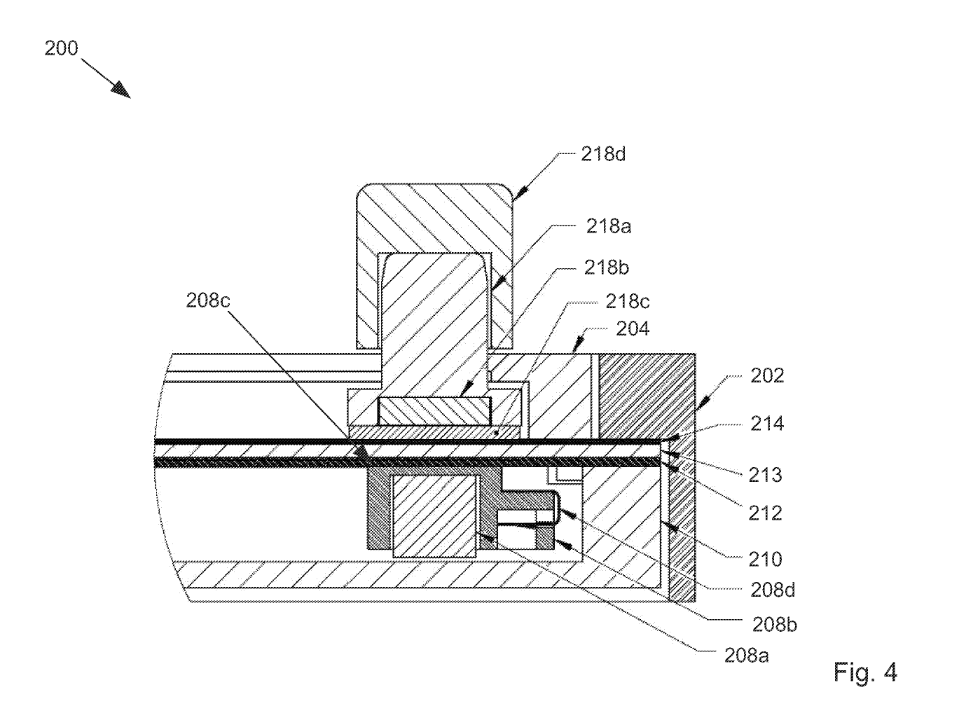

FIGS. 2-4 illustrate an input device 200, which can have features similar to or matching those of input device 100. The input device 200 includes an outer frame 202, a bezel 204, a plurality of slots 206 extending generally parallel to one another through the bezel 204, and a plurality of knobs 218, each of the knobs 218 slidably mounted within a respective one of the slots 206. Only one of the knobs 218 is shown in FIGS. 2-4. The input device 200 also includes a magnetically coupled slider 208, a housing 210, a circuitry layer 212, a sealing layer 214, and optionally, an optical layer including a clear light guide 213, which can be fabricated, for example, with acrylic or polycarbonate, and which can be edge-lit.

As illustrated in FIGS. 2-4, the housing 210 can form a base of the input device 200 and can include a plurality of grooves or channels 216 within which the magnetically coupled slider 208 can be slidably positioned. The channels 216 can be substantially parallel to one another and can be aligned parallel to and in alignment with the slots 206 of the bezel 204. The magnetically coupled slider 208 can be magnetic or can comprise a ferrous metal, or in some cases can comprise a central magnetic or ferrous portion 208a surrounded by a non-magnetic and non-ferrous outer portion 208b. As used herein, a “magnetic element” can refer to either a magnet or a ferrous metal. One or more sensory pathways can be coupled to the magnetically coupled slider 208. For example, an upper surface 208c of the magnetically coupled slider 208 can include conductive sensory pathways such as electrically conductive elements or electrically conductive tracks coupled thereto, such as to form a portion of a control circuit of the input device 200. In some cases, the conductive elements or tracks can comprise a conductive carbon compound. In various alternative embodiments, the slider 208 can comprise a spring finger (e.g., spring finger 208d), thin-coder balls, or an electro-resist film, any of which can include the electrically conductive elements or conductive tracks coupled to the upper surface 208c of the magnetically coupled slider 208.

The circuitry layer 212 can be a printed circuit board or other layer of material that carries or includes electrical circuitry and/or electronic components, such as electrically conductive elements or conductive tracks coupled to a bottom surface 212a thereof, which can interact with the sensory pathways of the magnetically coupled slider 208 to sense, detect, or measure movement of the magnetically coupled slider 208 with respect to the circuitry layer 212. In some cases, the conductive elements or tracks of the circuitry layer 212 can comprise a conductive carbon compound. The circuitry layer 212 can span across an entire upper surface of the housing 210, thereby enclosing the magnetically coupled slider 208 within the channel 216. The sealing layer 214 can be a membrane that spans across the entire upper surface of the circuitry layer 212 and light guide 213 to provide a seal for the circuitry layer 212, for the light guide 213, and for the channels 216. The sealing layer 214 can comprise a material having a relatively small coefficient of friction, or a relatively lubricious material such as a metal, such as brass, to allow other components such as the knob 218 to smoothly slide across it. Alternatively, the sealing layer 214 can comprise a relatively soft sealing material, such as a rubber, plastic, polymeric, elastic, or elastomeric sealing material. The sealing layer 214 can be transparent, and can comprise a decorated overlay that appears black when not back-lit, which can be referred to as having a “dead front.”

The outer frame 202 includes an outer wall 202b and an upper, inwardly protruding lip portion 202a. The lip portion 202a can be engaged with (e.g., adhered to) an upper surface of the sealing layer 214 to sandwich or compress the outer, peripheral edges of the sealing layer 214, light guide 213, and circuitry layer 212 between the lip portion 202a of the outer frame 202 and an upper surface of an outer, peripheral portion of the housing 210, thereby sealing and isolating the magnetically coupled slider 208, circuitry layer 212, and light guide 213 from an external environment. The seal thus provided can be water-tight and air-tight, and can provide a hermetic seal for the conductive circuitry coupled to the magnetically coupled slider 208 and circuitry layer 212.

The bezel 204 can be sized to fit within an inner perimeter of the lip portion 202a of the outer frame 202 so that the bezel 204 can be positioned against the sealing layer 214. As noted above, the bezel 204 can include a plurality of slots 206 extending generally parallel to one another through the bezel 204. Each of the slots 206 can include a relatively wide lower portion 206a and a relatively narrow upper or neck portion 206b. Put another way, the bezel 204 can include a peripheral wall 204a and an upper lip 204b that extends inwardly into the slot 206 from the peripheral wall 204a to form the slot 206. The upper lip 204b and corresponding neck portion 206b can allow the bezel 204 and slot 206 to capture the knob 218 to retain the knob 218 within the slot 206, as described further below.

The knob 218 can include a main body or stem 218a including a relatively wide base portion including a recess for receiving a magnetic element 218b and a relatively narrow top portion. The knob 218 can also include the magnetic element 218b and a bottom cover 218c coupled to (e.g., adhered or mechanically connected via protrusions 218e to) the relatively wide base portion of the stem 218a to cover the recess and magnetic element 218b, sealing the magnetic element 218b within the knob 218. The knob 218 can also include a cap 218d coupled to the relatively narrow top portion of the stem 218a. The bottom cover 218c can be positioned adjacent to or in contact with an upper surface of the sealing layer 214, and can comprise a relatively lubricious material to facilitate sliding of the knob 218 over the sealing layer 214.

The bottom cover 218c and the relatively wide base portion of the stem 218a can be sized to fit within the relatively wide lower portion 206a of the slot 206, and such that they cannot pass through the neck portion 206b of the slot 206. Thus, the knob 218 can be retained within the slot 208. The cap 218d can be coupled to the stem 218a to provide a user with a larger surface or a surface of a material different than that of the stem 218a to interact with, and can also be sized such that it cannot pass through the neck 206b of the slot 206. Thus, if the bezel 204 is removed from the rest of the input device 200, such as for cleaning, the knobs 218 are retained within the slots 206 and cannot pass through the slots 206 in either direction.

In this sense, the knob 218 is permanently coupled to the bezel 204 and therefore is less likely to be lost if and when the bezel 204 including the slots 206 and the knob 218 are removed from the rest of the input device 200, such as to allow the input device 200 to be cleaned. Further, the magnetically coupled slider 208 can remain in a given location while the input device 200 is cleaned. When the bezel 204 including the slots 206 and the knob 218 are returned to the rest of the input device 200, such as after the input device 200 has been cleaned, the magnetic element 218b can be attracted to the magnetically coupled slider 208, causing the knob 218 to slide through the slot 206 to find the given location of the magnetically coupled slider 208. In this way, after cleaning, the knob 218 can automatically return to the last location it occupied prior to cleaning. A user of the input device 200 can also slide the knobs 218 back and forth through the respective slots 206 after returning the bezel 204 to the rest of the input device 200 to restore the engagement between the knobs 218 and the respective magnetically coupled sliders 208.

In some cases, the magnetic element 218b can be a magnet having a polarity complementary to (e.g., opposite) that of a magnet of the magnetically coupled slider 208. Such an implementation can increase the magnetic force attracting the magnetically coupled slider 208 to the knob 218 and can allow the magnetically coupled slider 208 to follow the knob 218 more smoothly, more fluidly, and more precisely, by reducing the effects of friction and resulting jumps in the movement of the magnetically coupled slider 208 through a channel of the housing 210. In other cases, the magnetic element 218b can be a ferrous metal and the magnetically coupled slider 208 can include a magnet. In other cases, the magnetic element 218b can be a magnet and the magnetically coupled slider 208 can include a ferrous metal.

The magnetic element 218b and slider 208 can be in close enough proximity to one another that they magnetically attract one another and are magnetically coupled to one another. In use, a user of the input device 200 can actuate the knob 218 to move through the slot 206. As the knob 218 slides through the slot 206, the magnetic engagement of the magnetic element 218b and the slider 208 can cause the slider 208 to slide through the channel 216. As the slider 208 slides through the channel 216, the conductive pathways on the top surface 208c of the slider 208 can move across the conductive pathways formed on the bottom surface of the circuitry layer 212, thereby changing a control circuit of the input device 200 to cause changes in the operation of an external device or machine.

All of the electrical components and circuitry of the input device 200 can be sealed within the channels 216, and can be 100% isolated from an external environment of the input device 200. Thus, the input device 200 can be used in harsher environments than otherwise. For example, the input device 200 can be used underwater or in dusty or dirty environments without the electrical components being affected by the environment. The input device 200 can be used in close proximity to ultrasound gel or cleaning fluids without adverse effects to the operation of its circuitry. Further, the construction of the input device 200 allows the bezel 204 and knobs 218 to be removed from the rest of the input device 200 relatively easily (e.g., without disconnecting electrical components), such as for cleaning of the bezel 204 and knobs 218, or for other purposes, as necessitated, for example, by harsh environmental conditions.

In some embodiments, the bezel 204 can be back-lit, such as by providing LEDs underneath the sealing layer 214, such as between the sealing layer 214 and the circuitry layer 212 (e.g., mounted on the circuitry layer 212) or within the channel 216, such as at locations corresponding to locations 114 shown in FIG. 1. The bezel 204 itself and the knobs 218 can be opaque or translucent, and the light guide 213 and sealing layer 214 can be transparent, such that the back-lighting can allow a user to easily ascertain the position of the knob 218 within the slot 206, even in dark environmental conditions. The light guide 213 can have light extraction features printed, etched, or otherwise formed thereon, such as to facilitate the back-lighting of the bezel 204 by LEDs. In some cases, the knobs 218 can be transparent, and can allow light to pass through from the backlighting as well. Further, in some embodiments, the knobs 218 can include an additional lighting component, such as an LED located centrally on a top end of the knob 218, a light pipe, or other light transmission device, to further ease the task of locating the knob 218 in dark or other environmental conditions. Such an LED, light pipe, or other light transmission device can be provided with optical and/or electrical connections, such as to allow an operator to control the device and to allow the device to receive electrical power.

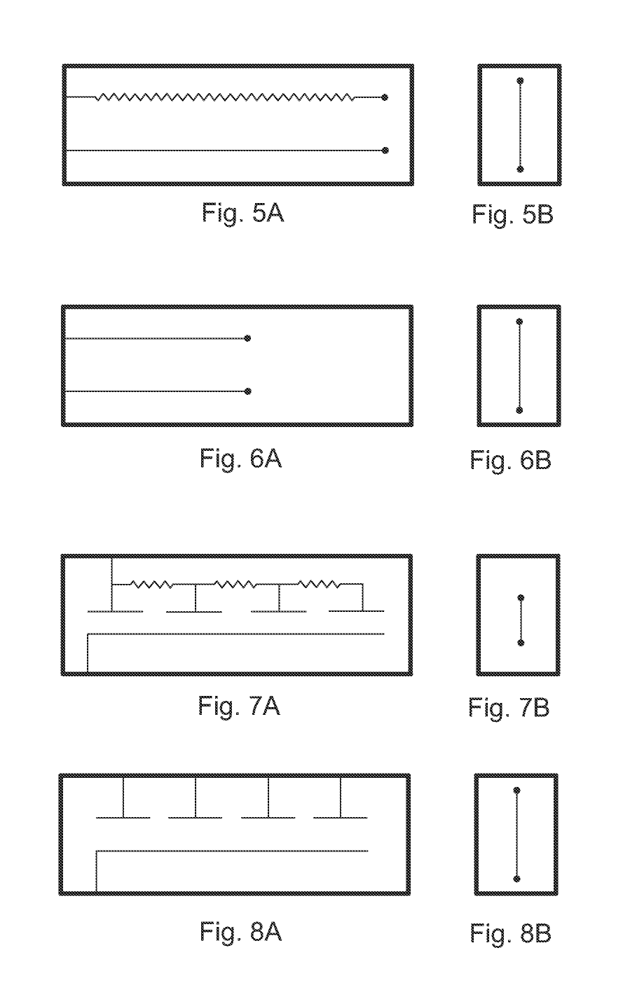

FIGS. 5A-11B illustrate various portions of control circuits that can be coupled to the bottom surface of the circuitry layer 212 or the top surface of the slider 208. In these figures, lines within the borders represent conductive pathways positioned on a non-conductive background. These figures illustrate only several possible examples of control circuits, and are not exhaustive of the possible control circuits, and the technologies described herein can be used with any suitable control circuit or combination of control circuits.

FIG. 5A illustrates a first portion of a first control circuit that can be coupled to the bottom surface of the circuitry layer 212 and FIG. 5B illustrates a second portion of the first control circuit that can be coupled to the top surface of the slider 208. In this embodiment, the first control circuit can provide a continuously variable resistance such as to provide a sliding potentiometer for continuously adjusting an operating parameter of an external device or machine.

FIG. 6A illustrates a first portion of a second control circuit that can be coupled to the bottom surface of the circuitry layer 212 and FIG. 6B illustrates a second portion of the second control circuit that can be coupled to the top surface of the slider 208. In this embodiment, the second control circuit can provide a relatively simple on/off or single-pole, single-throw, sliding switch.

FIG. 7A illustrates a first portion of a third control circuit that can be coupled to the bottom surface of the circuitry layer 212 and FIG. 7B illustrates a second portion of the third control circuit that can be coupled to the top surface of the slider 208. In this embodiment, the third control circuit can provide a stepwise-variable resistance such as to provide a mechanism for adjusting an operating parameter of an external device or machine in steps.

FIG. 8A illustrates a first portion of a fourth control circuit that can be coupled to the bottom surface of the circuitry layer 212 and FIG. 8B illustrates a second portion of the fourth control circuit that can be coupled to the top surface of the slider 208. In this embodiment, the fourth control circuit can provide a selector switch or a single-pole, multiple-throw (in this case, four-throw) switch that can complete different circuits based on the location of the knob 218 within the slot 206 and the slider 208 within the channel 216.

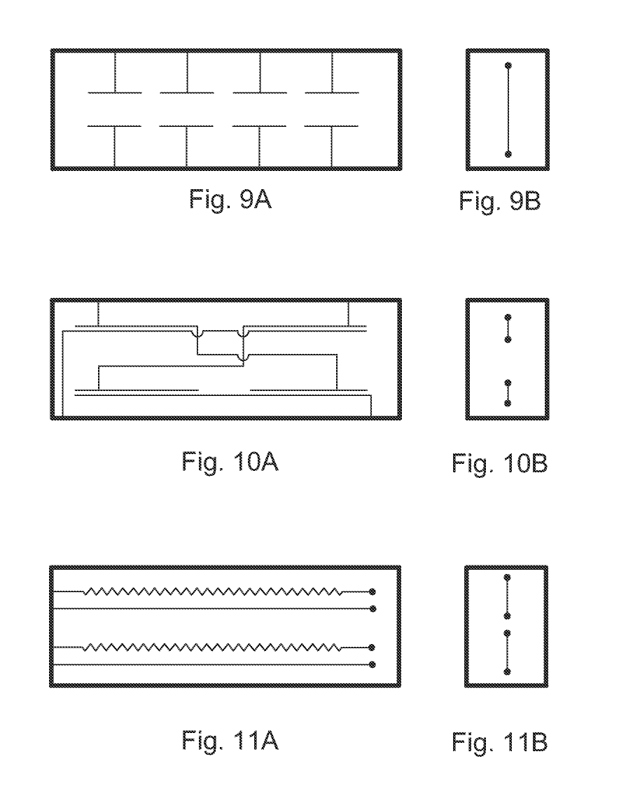

FIG. 9A illustrates a first portion of a fifth control circuit that can be coupled to the bottom surface of the circuitry layer 212 and FIG. 9B illustrates a second portion of the fifth control circuit that can be coupled to the top surface of the slider 208. In this embodiment, the fifth control circuit can provide a switch that can complete independent circuits based on the location of the knob 218 within the slot 206 and the slider 208 within the channel 216.

FIG. 10A illustrates a first portion of a sixth control circuit that can be coupled to the bottom surface of the circuitry layer 212 and FIG. 10B illustrates a second portion of the sixth control circuit that can be coupled to the top surface of the slider 208. In this embodiment, the sixth control circuit can provide a reversing switch that can reverse the connectivity of different circuits based on the location of the knob 218 within the slot 206 and the slider 208 within the channel 216.

FIG. 11A illustrates a first portion of a seventh control circuit that can be coupled to the bottom surface of the circuitry layer 212 and FIG. 11B illustrates a second portion of the seventh control circuit that can be coupled to the top surface of the slider 208. In this embodiment, the seventh control circuit can provide two independent continuously variable resistances such as to provide two sliding potentiometers having different but proportionally adjustable resistances for continuously adjusting at least two different operating parameters of an external device or machine.

As illustrated in FIGS. 11A and 11B, a single slider 208 can control multiple control circuits. The circuits controlled by a single slider 208 can include any combination of the circuits described above and illustrated in the Figures, or any other suitable or desirable circuit(s). Further, each of the plurality of sliders 208 provided in a single input device 200 can control different control circuits or different combination(s) of control circuits, including those described above or any other suitable or desirable control circuits.

As described above, in various alternative embodiments, the slider 208 can comprise a spring finger (e.g., spring finger 208d), thin-coder balls, or an electro-resist film. In some cases, the knob 208 can be pressed by a user, rather than or in addition to being pushed through the slot 206, to activate the electrically conductive elements or tracks coupled to the slider 208 to interact with the electrically conductive elements or tracks coupled to the circuitry layer 212, such as to complete an electric control circuit. In some cases, the electrically conductive elements can be pressure sensitive, such that, for example, the harder a user pushes on the knob 218, the more a resistance of an electric control circuit increases.

As described above, the sensory pathways of the magnetically coupled slider 208 can include electrically conductive elements or electrically conductive tracks which can interact with the corresponding electrically conductive elements or conductive tracks of the circuitry layer 212 to allow presence, absence, position, or movement (e.g., translation, rotation, or pivoting) of the magnetically coupled slider 208 and the knob 218 to be sensed, detected, or measured. In alternative implementations, however, other types of sensory pathways and other modes of interaction between the magnetically coupled slider 208 and the circuitry layer 212, such as non-contact and non-conductive modes of interaction, can be used to allow presence, absence, position, or movement (e.g., translation, rotation, or pivoting) of the magnetically coupled slider 208 and the knob 218 to be sensed, detected, or measured. As examples, the sensory pathways and the magnetically coupled slider 208 can interact with the electrical circuitry and/or electronic components of the circuitry layer 212 using inductive, capacitive, infrared, optical, acoustic, ultrasonic, ferroresistive, magnetoresistive, or other sensing techniques. As a specific example, in implementations in which a knob is not confined to move along the length of a slot, a circuitry layer can include a capacitive or resistive touchscreen to detect the presence, absence, position, or movement of a slider and a corresponding knob.

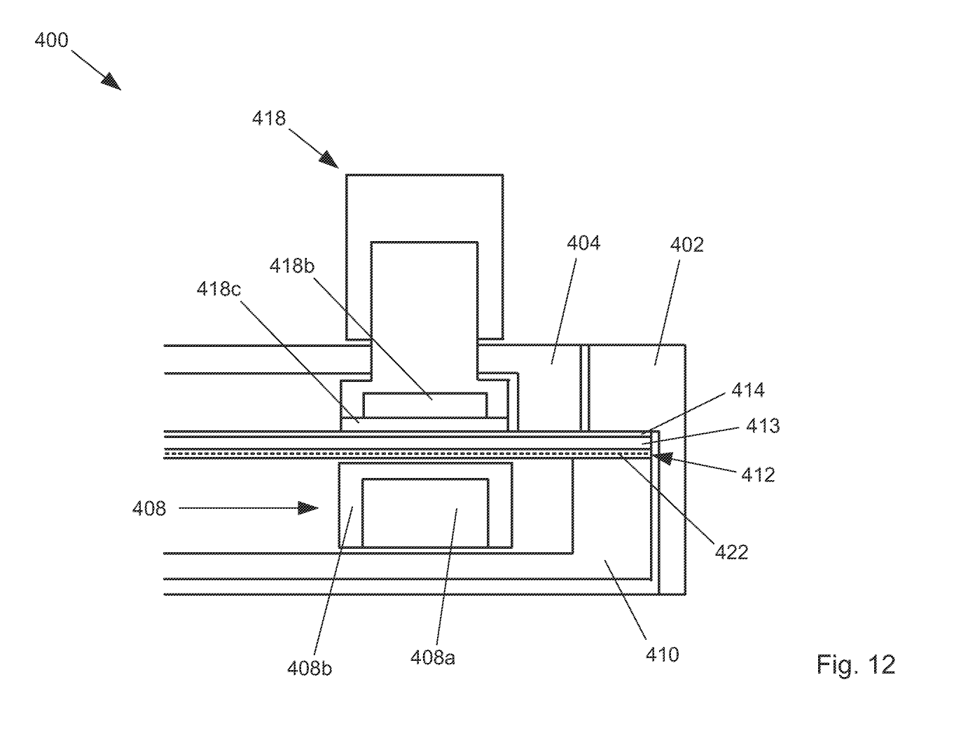

FIG. 12 illustrates a cross-sectional side view of an example of an input device 400 that is similar to input device 200 but uses inductive sensing techniques rather than conductive sensing techniques. The input device 400 includes an outer frame 402 similar to outer frame 202, a bezel 404 similar to bezel 204, a magnetically coupled slider 408 similar to magnetically coupled slider 208, a housing 410 similar to housing 210, a circuitry layer 412 similar to circuitry layer 212, an optical layer 413 similar to optical layer 213, a sealing layer 414 similar to sealing layer 214, and a knob 418 similar to knob 218.

The magnetically coupled slider 408 can include a magnetic element 408a similar to magnetic element 208a, which can include an electrically-conductive coating, and an outer housing 408b similar to the outer portion 208b, which can comprise a low-friction plastic. The electrically-conductive coating can be a conductive pathway or a sensory pathway. The knob 418 can include a magnetic element 418b similar to magnetic element 218b, and a bottom cover 418c similar to the bottom cover 218c, which can comprise a low-friction plastic.

The circuitry layer 412 can differ from the circuitry layer 212 in that it can omit the electrically conductive tracks of the circuitry layer 212 and include an inductive coil 422, indicated by the dashed line in FIG. 12, extending through a center of the circuitry layer 412. The inductive coil 422 can be positioned to interact with the electrically-conductively coated magnetic element 408a of the magnetically coupled slider 408, but can be separated from the magnetically coupled slider 408 by a bottom portion of the circuitry layer 412. For example, the electrically conductive coating of the magnetic element 408a can interact with an electric field of the inductive coil 422 as the magnetically coupled slider 408 moves through a channel of the housing 410 and across the circuitry layer 412. Thus, the input device 400 allows the magnetically coupled slider 408 to inductively interact with the circuitry layer 412 in a non-contact mode of interaction, which can reduce or eliminate wear and deterioration of the interacting components. Thus, any deterioration that does occur, such as to the housing 408b or the bottom surface of the circuitry layer 412, will not substantially affect the operation of the input device 400. Such non-contact modes of operation can allow the input device 400 to have a much longer operational lifetime than other input devices that use contact-based (e.g., conductive) modes of interaction. For example, the input device 400 can operate for well over 10,000 cycles, which is a common expected lifetime of devices relying on contact-based modes of interaction.

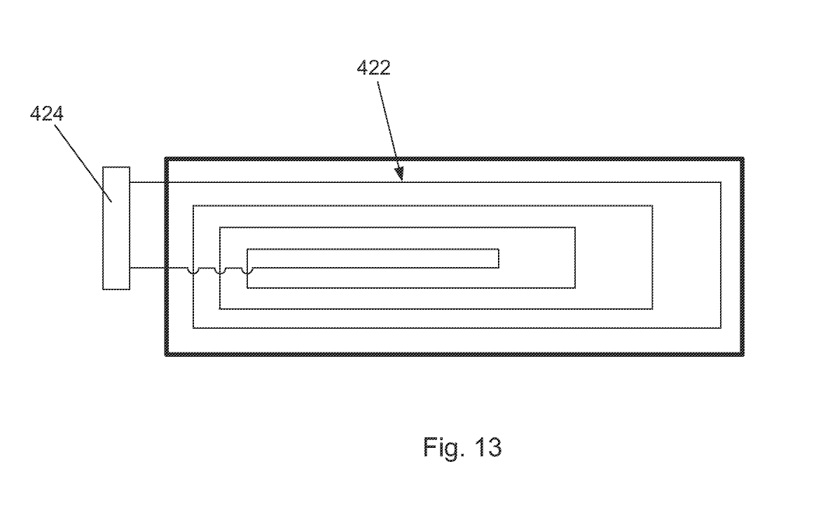

FIG. 13 shows a schematic of the inductive coil 422 in plan view. The inductive coil 422 can have a varying pitch such that movement of the electrically-conductively coated magnetic element 408a across the inductive coil 422 can cause changes in the inductance of the inductive coil 422. The inductive coil 422 can be coupled to an electronic component 424 capable of measuring the inductance of the inductive coil 422. As an example, the electronic component 424 can be a commercially available inductance to digital converter such as the TI LDC 1614 product available from Texas Instruments. Thus, the electronic component 424 can sense, detect, or measure the position of the knob 418 within the input device 400 in the same ways described herein with respect to the input device 200, and can use such information in the same ways described herein with respect to the input device 200.

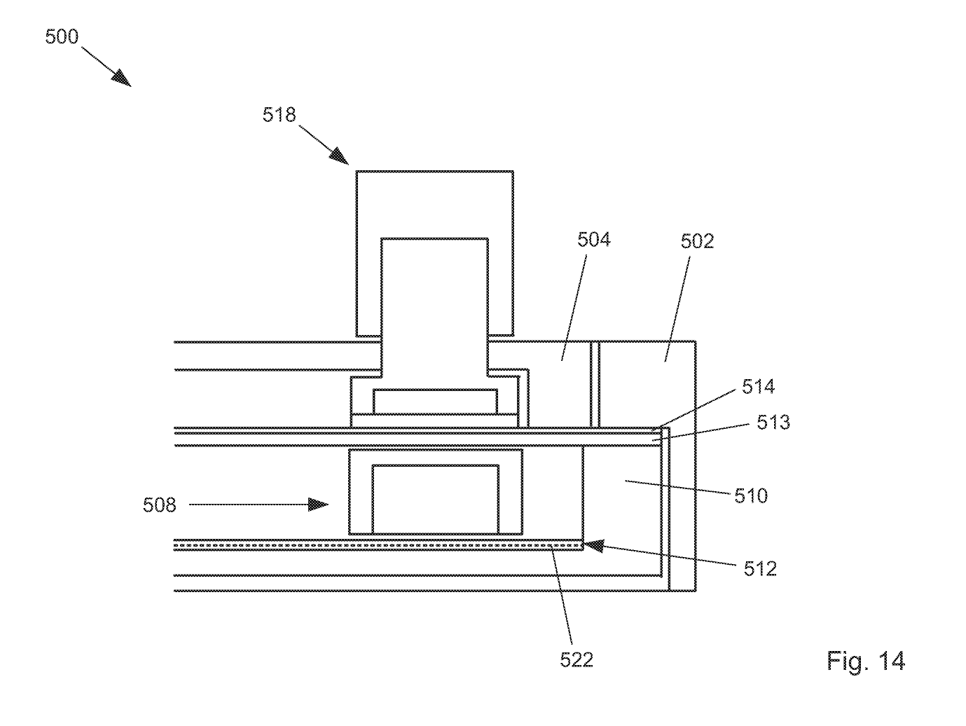

FIG. 14 illustrates a cross-sectional side view of another example of an input device 500 that is similar to input device 400. The input device 500 includes an outer frame 502 similar to outer frame 402, a bezel 504 similar to bezel 404, a magnetically coupled slider 508 similar to magnetically coupled slider 408, a housing 510 similar to housing 410, a circuitry layer 512 including an inductive coil 522 similar to circuitry layer 412 and inductive coil 422, an optical layer 513 similar to optical layer 413, a sealing layer 514 similar to sealing layer 414, and a knob 518 similar to knob 418.

The input device 500 can differ from the input device 400 in that, whereas in the input device 400 the circuitry layer 412 including the inductive coil 422 is positioned between the knob 418 and the magnetically coupled slider 408, in the input device 500 the circuitry layer 512 including the inductive coil 522 is positioned below the magnetically coupled slider 508, between the housing 510 and the magnetically coupled slider 508. In both the input device 400 and the input device 500, the respective circuitry layer is positioned between the respective housing and the respective knob.

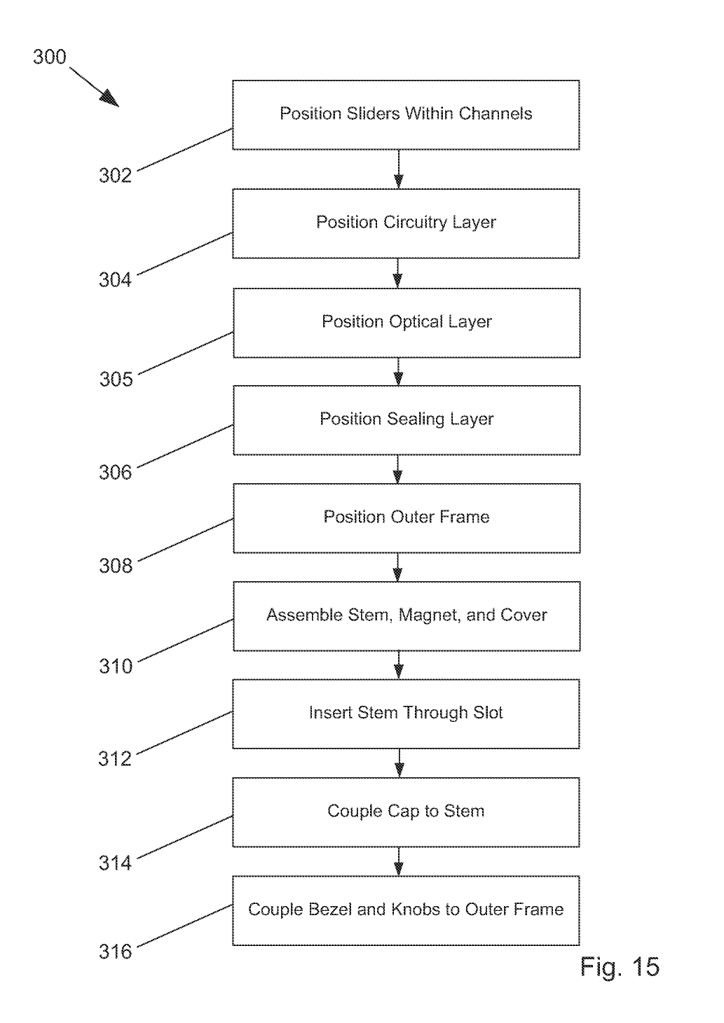

FIG. 15 is a flow chart diagram showing a method 300 of assembling the input device 200. The method 300 includes positioning the sliders 208 within the channels 216 of the housing 210 at 302. The method 300 can further include positioning the circuitry layer 212 to cover the sliders 208, channels 216, and housing 210 at 304. The method 300 can further include positioning the light guide 213 and sealing layer 214 to cover the circuitry layer 212 at 305 and 306, respectively. The method 300 can further include positioning the outer frame 202 to compress the peripheral edge portions of the circuitry layer 212, light guide 213, and sealing layer 214 between the outer frame 202 and the housing 210 at 308 to seal the sliders 208, circuitry layer 212, and light guide 213 within the input device 200 so they are isolated from an external environment. Positioning the outer frame 202 to compress and seal these components can include screwing the outer frame 202 into screw holes 220 formed at each of the four corners of the housing 210.

The method 300 can further include assembling the stem 218a, magnetic element 218b, and bottom cover 218c at 310 to form a portion of the knob 218. The method 300 can further include inserting the stem 218a through the slot 206 of the bezel 204 at 312. The method 300 can further include coupling the cap 218d to the stem 218a at 314 to form the completed knob 218 which is retained within the slot 206 and restrained against motion with respect to the bezel 204 in either direction through the slot 206. The method 300 can further include coupling the bezel 204 and knobs 218 to the outer frame 202 at 316 to position the sliders 208 sufficiently close that the sliders 208 are magnetically coupled to the magnetic elements 218b.

This application claims priority to, and hereby incorporates by reference, U.S. provisional patent application No. 62/165,530, filed on May 22, 2015. Those of skill in the art will recognize that many of the methods or algorithms set out herein may employ additional acts, may omit some acts, and/or may execute acts in a different order than specified. The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. An input device comprising:
a knob including a first magnetic element;
a housing;
a slider positioned within the housing;
a circuitry layer positioned between the knob and the housing; and
the slider including a second magnetic element magnetically coupled to the first magnetic element to move the slider within the housing to interact with the circuitry layer as the knob moves.

2. The input device of claim 1 wherein the circuitry layer and the slider form a continuously variable resistor.

3. The input device of claim 1 wherein the circuitry layer and the slider form a single-pole, single-throw switch.

4. The input device of claim 1 wherein the input device is coupled to an ultrasound system.

5. The input device of claim 1 wherein the housing is sealed and the slider is isolated from an external environment.

6. The input device of claim 1 wherein the first magnetic element is a magnet and the second magnetic element is a ferrous metal.

7. The input device of claim 1 wherein the first magnetic element is a ferrous metal and the second magnetic element is a magnet.

8. The input device of claim 1 wherein the first magnetic element is a first magnet having a first polarity and the second magnetic element is a second magnet having a second polarity, the first polarity opposite to the second polarity.

9. The input device of claim 1 wherein the slider includes a conductive pathway.

10. The input device of claim 1 wherein the circuitry layer is positioned between the knob and the slider.

11. The input device of claim 1 wherein the circuitry layer is positioned between the slider and the housing.

12. The input device of claim 1, further comprising a bezel including a slot, wherein the knob is positioned to slide through the slot.

13. A method of assembling an input device, comprising:
positioning a slider including a first magnetic element within a housing;
positioning a circuitry layer to communicatively interact with the slider; and
positioning a knob including a second magnetic element so the circuitry layer is positioned between the knob and the housing and so the second magnetic element is magnetically coupled to the first magnetic element, so the slider moves within the housing and communicatively interacts with the circuitry layer as the knob moves.

14. The method of claim 13, further comprising moving the knob, thereby moving the slider within the housing such that the slider communicatively interacts with the circuitry layer.

15. The method of claim 14 wherein moving the knob includes adjusting a continuously variable electrical signal.

16. The method of claim 14 wherein moving the knob includes throwing a single-pole, single-throw switch.

17. The method of claim 14 wherein moving the knob includes controlling an ultrasound system.

18. The method of claim 13, further comprising sealing the housing and isolating the slider from an external environment.

19. The method of claim 13 wherein the first magnetic element is a magnet and the second magnetic element is a ferrous metal.

20. The method of claim 13 wherein the first magnetic element is a ferrous metal and the second magnetic element is a magnet.

21. The method of claim 13 wherein the first magnetic element is a first magnet having a first polarity and the second magnetic element is a second magnet having a second polarity, the first polarity opposite to the second polarity.

22. The method of claim 13 wherein the circuitry layer is positioned to conductively interact with the slider.

23. The method of claim 13 wherein the circuitry layer is positioned to inductively interact with the slider.
